(19) United States
(12) Patent Application Publication
(10) Pub. No.: US 2003/0233446 A1
(43) Pub. Date: Dec. 18, 2003

(54) System and method for managing a distributed computing system

(76) Inventor: William J. Earl, Boulder Creek, CA (US)

Correspondence Address: GRAY CARY WARE & FREIDENRICH LLP, 2000 UNIVERSITY AVENUE, E. PALO ALTO, CA, 94303-2248, US

(21) Appl. No.: 10/170,880

(22) Filed: Jun. 12, 2002

(51) Int. Cl. G06F 15/173

(52) U.S. Cl. 709/224; 709/220

(57) ABSTRACT

A system and method managing a distributed computing system having a plurality of resources. The system includes a pair of system management servers that are communicatively connected to the plurality of resources. The system management servers receive a requested view of the computing system from a user, representing the desired functionalities or attributes of the computing system. The servers further monitor an implemented view of the computing system, representing the actual state or attributes of the computing system. The servers compare the implemented view to the requested view and automatically and dynamically configure the plurality of system resources such that the implemented view consistently satisfies the requested view.

### TECHNICAL FIELD

The present invention relates generally to computing systems, and more particularly to a system and method for managing a highly scalable, distributed computing system. The present invention automatically provisions system resources to match certain user-selected functionalities and performance attributes, and dynamically configures and allocates system resources to conform to modifications in the user-selected attributes and/or to changes in system resources.

### BACKGROUND OF THE INVENTION

In order to manage conventional distributed computing systems, a system administrator is required to specifically configure and allocate the resources of the system so that the system provides certain functionalities and performance attributes. For example, management of a distributed file system may include defining a new file system through administrative interfaces, provisioning resources for the file system, and enabling the file system for access (both after provisioning and on any later system startup, should the system ever be shutdown). Management may also include requesting the deletion of a file system through the administrative interface, disabling a file system from access (e.g., when deletion is requested or when system shutdown is requested), and releasing provisioned resources for a file system being deleted. A system administrator may further be required to reassign and reconfigure system resources to satisfy changes in functionality and performance requirements and/or to maintain certain functionality and performance attributes in the presence of failures, additions or modifications in system resources.

In conventional computing systems, all of the foregoing management functions are typically performed by a system administrator. This requires constant effort and attention by the system administrator. Particularly, a system administrator must constantly monitor, provision, configure and modify system resources in order to achieve and maintain the desired results. This undesirably increases the cost and time required to manage and maintain the computing system.

It is therefore desirable to provide a system for managing a distributed computing system that requires a system administrator to only specify or select certain functionalities and performance attributes (e.g., the desired results), and does not require the administrator to provision or configure system resources to achieve and maintain the desired results. Accordingly, the present invention provides a system for managing a distributed computing system, which automatically configures system resources to match certain user-selected functionalities and performance attributes, and dynamically configures and allocates system resources to conform to modifications in the user-selected attributes and/or to changes in the state of system resources.

### SUMMARY OF THE INVENTION

One non-limiting advantage of the present invention is that it provides a system for managing a distributed computing system that allows a system administrator to input certain functionalities and performance attributes and that automatically provisions system resources to achieve the desired results.

Another non-limiting advantage of the present invention is that it provides a system for managing a distributed computing system that autonomously reconfigures system resources to conform to modifications in the desired functionality or performance requirements and/or to changes in the state of system resources.

Another non-limiting advantage of the present invention is that it allows a system administrator to simply input certain functionality and performance attributes to achieve certain desired results, and does not require the administrator to specifically provision system resources in order to obtain the results. While the system may provide some reporting and visualization of how resources are being used (e.g., for system development and monitoring purposes and/or for customer viewing), such reporting and visualization is not required for normal use or management of the system.

Another non-limiting advantage of the present invention is that it provides a system and method for managing the resources of a file system. The system supports a large number of file systems, potentially a mix of large and small, with a wide range of average file sizes, and with a wide range of throughput requirements. The system further supports provisioning in support of specified qualities of service, so that an administrator can select values for performance attributes (such as capacity, throughput and response time) commonly used in service level agreements.

Another non-limiting advantage of the present invention is that it provides an interface that allows a system administrator to enter a requested view, which may represent the desired state or performance of the system, as specified by the administrator. The interface may further display an implemented view, which reflects the actual state or performance of the system. The implemented view may reflect changes which are in progress, but not yet complete, such as the provisioning of a newly created file system. It may also change from time to time, even if the requested view does not change, as resources are reallocated or migrated, to better balance the load on the system and to recover from component failures. The system automatically and constantly drives the system resources to best match the implemented view to the requested view.

According to one aspect of the present invention, a system is provided for managing a distributed computing system having a plurality of resources. The system includes at least one server which is communicatively connected to the plurality of resources, and which is adapted to receive requested attributes of the distributed computing system from a user, and to automatically and dynamically configure the plurality of resources to satisfy the requested attributes.

According to a second aspect of the invention, a system is provided for managing a distributed file system having a plurality of resources. The system includes an interface that is adapted to allow a user to input a requested view of the file system, representing at least one desired attribute of the file system; a first portion that is adapted to monitor an implemented view of the file system, representing at least one actual attribute of the file system; a second portion that is adapted to store the requested view and implemented view; and at least one server that is communicatively coupled to the first portion, second portion and the plurality of resources, the at least one server being adapted to compare requested view to the implemented view, and to automatically and dynamically modify the plurality of resources such that the implemented view matches the requested view.

According to a third aspect of the present invention, a method is provided for managing a plurality of resources in a distributed computing system. The method includes the steps of: receiving a requested view of the distributed computing system, representing at least one requested attribute of the distributed computing system; monitoring an implemented view of the distributed computing system, representing at least one actual attribute of the distributed computing system; comparing the requested view to the implemented view; and automatically and dynamically configuring the plurality of resources to ensure that the implemented view consistently satisfies the requested view.

These and other features and advantages of the invention will become apparent by reference to the following specification and by reference to the following drawings.

### BRIEF DESCRIPTION OF THE DRAWINGS

FIG. 1 is a block diagram of an exemplary distributed computing system incorporating one embodiment of a system and method for managing the system.

FIG. 2 is a block diagram illustrating the general operation of the management system shown in FIG. 1.

FIG. 3 illustrates an exemplary embodiment of an update screen of a graphical user interface that may be used with the present invention.

FIG. 4 illustrates an exemplary embodiment of a monitor screen of a graphical user interface that may be used with the present invention.

FIG. 5 is a block diagram illustrating an exemplary method for initiating a modification state machine in response to a change in the requested view, according to one embodiment of the invention.

FIG. 6 is a block diagram illustrating an exemplary method for initiating a modification state machine in response to a change in the state of system resources, according to one embodiment of the invention.

FIG. 7 is a block diagram illustrating an exemplary method for initiating a modification state machine in response to a load imbalance on the system, according to one embodiment of the invention.

FIG. 8 is a block diagram illustrating an exemplary modification routine or method, according to one embodiment of the invention.

FIG. 9 is a block diagram of the resources of a distributed computing system, illustrating the varying size and usage of the resources.

### DETAILED DESCRIPTION OF THE EMBODIMENTS

The present invention will now be described in detail with reference to the drawings, which are provided as illustrative examples of the invention so as to enable those skilled in the art to practice the invention. The present invention may be implemented using software, hardware, and/or firmware or any combination thereof, as would be apparent to those of ordinary skill in the art. The preferred embodiment of the present invention will be described herein with reference to an exemplary implementation of a file system in a distributed computing system. However, the present invention is not limited to this exemplary implementation, but can be practiced in any computing system that includes multiple resources that may be provisioned and configured to provide certain functionalities, performance attributes and/or results.

I. General System Architecture

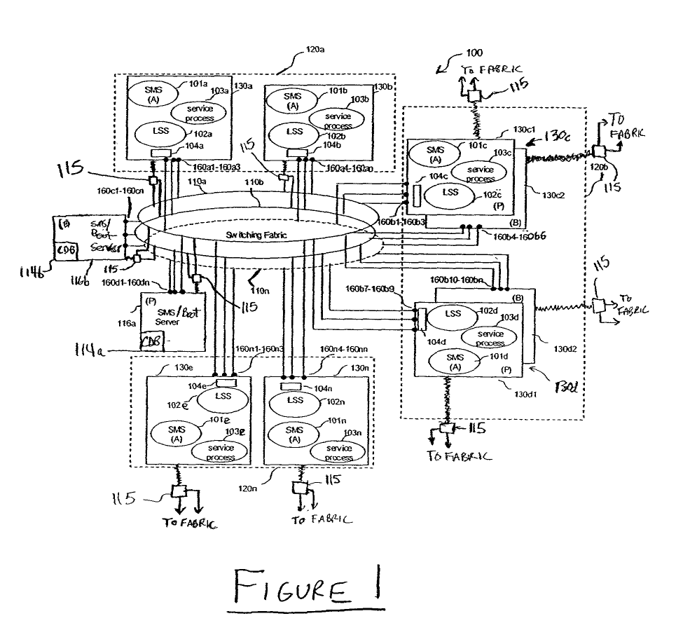

Referring now to FIG. 1, there is shown an exemplary highly scalable, distributed computing system 100 incorporating a system and method for managing system resources, according to one embodiment of the invention. The distributed computing system 100 has a plurality of resources, including service nodes 130a-130n and a Systems Management Server (SMS)/boot server pair 116a, 116b. The system 100 may also include a plurality unallocated or unassigned resources (not shown). Each SMS server 116a, 116b may comprise a conventional server, computing system or a combination of such devices. Each SMS server 116a, 116b includes a configuration database (CDB) 114a, 114b, which stores state and configuration information regarding the system 100, including the requested and implemented views of the file system, which are described more fully and completely below. One of the SMS server pair 116a, 116b (e.g., SMS server 116a) may serve as the primary SMS server, while the other (e.g., SMS server 116b) may act as a backup, which is adapted to perform the same functions as the primary SMS server in the event that the primary SMS server is unavailable. The SMS server pair 116a, 116b each include an SMS monitor, which may comprise hardware, software and/or firmware installed on the SMS server pair that is adapted to perform system management services. These services include autonomously and dynamically provisioning and modifying system resources to ensure that the system provides certain user-selected performance attributes and functionality. The SMS server pair 116a, 116b is further responsible for other management services such as starting, stopping, and rebooting service nodes, and for loading software onto newly activated nodes. It should be appreciated that in alternate embodiments the SMS Server pair 116a, 116b may comprise additional disparate devices that perform one or more of the foregoing functions (e.g., separate dedicated boot servers). In the following discussion, the SMS Server pair 116a, 116b may be collectively referred to as the SMS Monitor 116, and the CDB pair 114a, 114b may be collectively referred to as the CDB 114. Furthermore, the term “n” is used herein to indicate an indefinite plurality, so that the number “n” when referred to one component does not necessarily equal the number “n” of a different component. For example, the number of service nodes 130a-130n need not, but may, equal the number of services 120a-120n.

Each service node within system 100 is connected by use of an interface (e.g., 160al-160an, 160bl-160bn, 160nl-160nn) to at least a pair of switching fabrics 110a-110n, which may comprise for example, but without limitation, switched Internet Protocol (IP) based networks, buses, wireless networks or other suitable interconnect mechanisms. Switching fabrics 110a-110n can provide connectivity to any number of service nodes, boot servers, and/or function-specific servers such as the SMS Monitor 116, the management entity.

The system 100 further includes a plurality of remote power control units 115 that are coupled to the various nodes of the system (e.g., to service nodes 130a-130n and SMS servers 116a, 116b) and that provide an outside power connection to the nodes with “fail hard” and reset control. Particularly, the remote power control units 115 allow the SMS Monitor 116 to selectively force the nodes to stop or cause the nodes to start or reset from a location exterior to each component. Particularly, the SMS Monitor 116 selectively communicates control signals to the power control units 115, effective to cause the units to selectively stop or reset their respective nodes. Each power control unit 115 may be coupled to the switching fabric 110a-110n through a redundant path, thereby allowing the SMS Monitor 116 to control the nodes even in the event of a single path failure.

In the preferred embodiment, each service node 130a-130n in system 100 may include at least one service process 103a-103n, which can be, for example but without limitation, a gateway process, metadata process, or storage process for a file system. Each service node 130a-130n can be a single service instance (e.g., service node 130a or 130b), or a primary service instance (e.g., service node 130c1 or 130d1) and one or more backup service instances (e.g., service node 130c2 or 130d2). The primary service instance and its one or more backup service instances in most cases reside on separate physical machines to ensure independent failure, thereby avoiding the primary service instance and its one or more backup service instances failing together. Services 120a-120n, regardless of whether they provide a single service instance or primary and backup service instances, typically provide different functions within a distributed computing system. For example, but without limitation, one service may provide a distributed, scalable, and fault-tolerant metadata service (MDS), while another may provide a distributed, scalable gateway service (GS), a distributed scalable bit file storage service (BSS), or some other service. Examples of metadata, gateway and storage services are described in U.S. patent application Ser. No. 09/709,187, entitled “Scalable Storage System,” which is assigned to the present assignee, and which is fully and completely incorporated herein by reference.

Each service node 130a-130n in system 100 may also include a life support service (LSS) process 102a-102n. The LSS processes monitor the state and operability of the components and services of the distributed computing system 100. This state and operability information may be communicated to the SMS Monitor 116, which may utilize the information to determine how system resources should be allocated or modified to achieve certain user-selected performance attributes and functionality. The function of the LSS system is fully and completely described in co-pending United States Patent Application, entitled “System and Method for Monitoring the State and Operability of Components in Distributed Computing Systems,” which is assigned to the present assignee, and which is fully and completely incorporated herein by reference.

Each service node 130a-130n in system 100 also includes an SMS agent process 101a-101n, which is a managed entity used by the SMS Monitor 116 to remotely manage a service node (e.g., to start, stop, and reboot a service node). Each agent may include fault tolerant software loading mechanisms that can be remotely directed by the SMS Monitor 116 to load software onto the nodes. In one embodiment, the software for all nodes is stored in two separate boot server portions of the SMS Monitor 116.

It should be noted that the present invention allows the components of the service nodes to receive messages directly from the SMS Monitor 116 and other components through the switching fabric 110a-110n, or alternatively, such messages may be mediated by another layer of communication software 104a-104n, according to a known or suitable mediation scheme.

In accordance with the principles of the present invention, the foregoing nodes and services are provided for purposes of illustration only and are not limiting. The resources of the system 100 may be used for any function or service, for example but not limited to, a highly scalable service and a fault-tolerant service. Furthermore, while only three services (i.e., services 120a, 120b, 120n), and two SMS/boot servers (i.e., servers 116a, 116b) are shown, many more of each of these services and servers may be connected to one another via switching fabrics according to the present invention.

II. Operation of the System

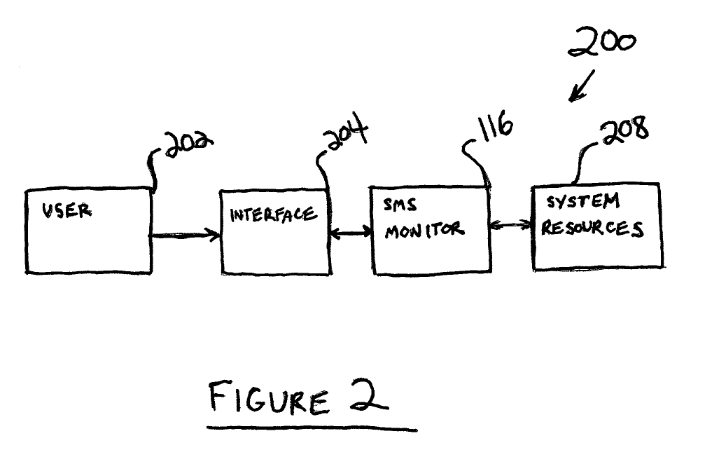

Referring now to FIG. 2, there is shown a block diagram illustrating the general operation of a system 200 for managing resources in a distributed computing system such as system 100, according to a preferred embodiment of the invention. A user 202 of the system 200 may be a system administrator. As shown in FIG. 2, the user 202 enters certain functionalities and/or performance attributes that are desired and/or required of the computing system into the SMS Monitor 116 by use of an interface 204. The user 202 simply inputs certain functionality and performance attributes (e.g., the desired results), and does not enter the specific procedures or instructions that would be required to provision system resources in order to obtain the results in conventional systems. For example, in a file system application, a user 202 may input attributes such as average file size, number of files, space limit, bandwidth, and/or operations per second. The SMS Monitor 116 uses these attributes to create a requested view of the file system, which represents or reflects these desired attributes.

The SMS Monitor 116 further automatically provisions the system resources 208 so that the file system achieves the desired results. The SMS Monitor 116 further creates an implemented view of the file system which reflects the actual state or performance of the system. The implemented view will, in general, reflect changes which are in progress, but not yet complete, such as the provisioning of a newly created file system. The implemented view may also be changing from time to time, even if the requested view does not change, as resources are reallocated or migrated, to better balance the load on the system and to recover from component failures.

The SMS Monitor 116 constantly compares the implemented view of the file system to the requested view and modifies, reassigns and/or reconfigures system resources 208 so that the implemented view substantially matches or mirrors the requested view. For instance, if a user 202 alters the requested view, the SMS Monitor 116 will modify, reassign and/or reconfigure system resources 208 (if necessary) to provide the updated desired results. Likewise, if there are modifications, additions, problems or failures with system resources 208, the SMS Monitor 116 may modify, allocate and/or reconfigure system resources 208 (if necessary) so that the implemented view continues to substantially match or satisfy the requested view.

In order to provide this automatic “reprovisioning” function, the SMS Monitor 116 maintains records identifying resource allocation and status (e.g., within the CDB 114). When the SMS Monitor 116 receives notification of a change of status in one or more system resources (e.g., from the LSS process), the SMS Monitor 116 will look up the relevant allocation(s) and determine whether the desired state matches the current state. If the change in status represents the failure of a system resource, the SMS Monitor 116 will try to restart or reboot the resource. If the resource is still not functioning properly, the SMS Monitor 116 will initiate a modification subroutine to modify and/or reallocate system resources so that the implemented view again substantially matches the requested view. The various procedures performed by the SMS Monitor 116 to modify system resources are more fully and completely described below in Section II.E.3.

The requested view and the implemented views may be stored in separate, but parallel, sets of records (e.g., in the CDB 114). The implemented view on initial creation may be a copy of the requested view, with some extra fields filled in, depending on the object type. For updates, particular fields may be copied, but only as required updates to the running state of the system are determined to be feasible.

A. User Interface

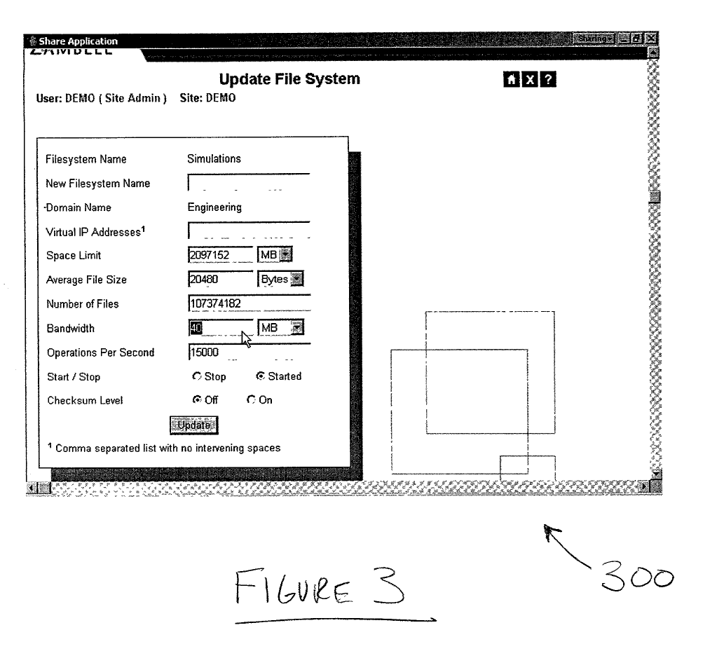

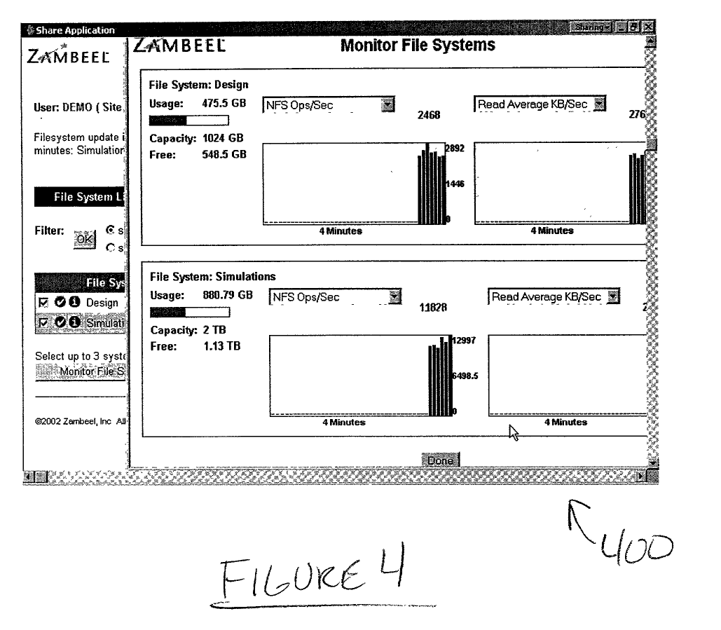

The system 200 utilizes a conventional user interface 204 that allows a user, such as a system administrator, to create and modify file systems and their respective performance parameters. The interface 204 may also provide reporting and visualization of how resources are being used for system development and monitoring purposes and for customer viewing. However, such reporting and visualization is not required for normal use and management of the system. The user interface 204 may comprise a command line interface (CLI), a web server interface, an SNMP server interface and/or a graphical user interface (GUI). FIG. 3 illustrates an exemplary embodiment of a modification screen 300 of a graphical user interface that may be used with the present invention. Interface screen 300 allows a user to update or modify file system parameters. For example, interface screen 300 includes fields that allow a user to change the name, virtual IP addresses, space limit, average file size, number of files, bandwidth, and operations per second of the file system. FIG. 4 illustrates an exemplary embodiment of a screen 400 that allows a user to view the actual performance of the file system. The user may request to view performance parameters such as capacity, free space, usage, operations per second (NFS Ops/Second), average read and write operations per second (e.g., in KB/Sec), and other relevant performance parameters. In alternate embodiments, any other suitable performance parameters may be displayed. In the preferred embodiment, the graphical user interface may also include additional screens allowing users to create, enable, disable and delete file systems, to generate system usage and other reports, and to perform any other suitable administrative functions.

B. File System Requested View

In the preferred embodiment, the file system requested view may include information that is manageable by the user, such as system performance and functionality information. If an attribute is not manageable by the user, then it need not (but may) be visible to the user and need not (but may) be part of the “requested view” section of the CDB.

In the preferred embodiment, the requested view may include a “filesystem” entity that represents a complete file system. All required attributes must be set before the “filesystem” entity is considered complete. A user may create, modify, start, stop and delete a “filesystem” entity in the requested view. Deleting a “filesystem” entity represents a request to delete the file system defined by the entity. The request is not complete until the file system has disappeared from the file system implemented view.

The “filesystem” entity may also have a corresponding status attribute and progress and failure informational report attributes for each of creation, deletion, start, stop, and modification. The status attribute may indicate “not begun”, “in progress”, “completed”, or “failed”, and the progress and failure informational reports may indicate any reasons available for those status values. In particular, the “in progress” status may have an informational report which indicates the stage of that action. The “failed” status may have an informational report indicating the reason, usually resource limitation or quota exhaustion.

The requested view is never changed by the system on its own, except to update the status attributes. If an update cannot be realized (e.g., because a desired service level agreement (SLA) cannot be met due to lack of resources), this may be indicated in the status (as well as by an alert based on a log message).

This may be true even if the update is initially successful, but resources are later lost, so that it is no longer feasible to meet a service level agreement (SLA). In both cases, the system indicates that the current implemented view does not reflect the requested view to some degree. Note that synchronous updates to the requested view, invoked by the administrative interface, may perform some consistency and feasibility checking, but that checking can always be invalidated by asynchronous events (such as an unexpected loss of resources). That is, the SMS Monitor 116 tries to reject impossible requests, but it will never be possible to avoid later asynchronous failures in all cases, so the architecture has to support both failure models.

Customers (e.g., users or system administrators), user sets, and file systems may be assigned unique identifiers when first processed by the management software. File systems may be renamed without changing the unique identifier. If a file system is deleted from the requested view and a new file system with the same name is then created in the requested view, the two file systems will be different (and any data in the first file system will be lost when it is deleted).

C. File System Implemented View

In the preferred embodiment, the file system implemented view may be stored in a system-private area of the CDB 114, e.g., in an area not visible to users or customers. The file system implemented view entities may be stored under a top-level “_filesystems” area of the CDB 114. Each filesystem entity in the implemented view may include an attribute which specifies a customer/user unique ID of the file system. One may use the customer unique ID and file system unique ID to look up the requested view for the file system, if any.

The implemented view may include additional attributes which are used to represent the state of the file system with respect to creation, modification, startup, shutdown, and shutdown. It may also includes attributes which record the provisioned resources, if any.

D. State Machine Management

In the preferred embodiment, system 200 models the various operations on a file system (e.g., system 100) as state machines, which implicitly order the various steps in a given operation. In the preferred embodiment, the SMS Monitor 116 includes state machines for all necessary file system functions, such as but not limited to, file system create, modify, delete, start and stop. In some cases, such as a provisioning failure, one state machine may terminate after starting another state machine in an intermediate state. For example, if the second of several steps in file system creation fails, it will terminate the creation state machine and start the deletion state machine two steps from its final state (to reverse just those steps in creation already completed). Also, a state machine such as deletion, which may require that the file system first be shut down, may start the shutdown state machine, and then trigger on the completion of that state machine.

The SMS Monitor 116 manages the state machines, and may have built into it the sequence of states, including arcs for certain error and premature termination conditions. The state values may be reported in symbolic form, and stored in binary form. The state attributes for a file system are repeated in both the implemented and requested views. (Note that attempts to set the state attributes in the requested view are ignored.)

The state machines may be executed in two states, “prepare” and “action”, where the “prepare” state serves as a synchronization point for external events, and the “action” state performs the desired file system function (e.g., create, modify, start, stop, and the like). For states in the “prepare” class, the SMS Monitor 116 checks for conditions which may lead to premature termination of the state machine (such as a request to delete a file system while it is being created, started, or modified), and changes the state appropriately (e.g., to an “SMS Failed” state in the case of deletion being requested during creation). If no such conditions exist, it automatically advances the state to the corresponding state of the “action” class, which then runs to completion, despite any external actions, at which point the state advances to the next state of the “prepare” class. This use of a “prepare” and an “action” class provides an opportunity for an early termination from file system operations, which will save time and resources in the event that an operation will ultimately fail.

The SMS Monitor 116 may include various functions to manage the state machines. There may be defined symbols for an enumeration of state machines, and for enumerations of the various states of those state machines. In this manner, the SMS Monitor 116 can maintain an internal table which defines the sequence of states for each state machine and, for each state, the state machine values to be forced in the event of an error in that state, as well as any other attributes which may force a non-standard state transition.

The SMS Monitor state machine engine is executed as part of a top level loop of the SMS Monitor 116, and may call handler routines specific to various service masters. In the SMS Monitor 116, service masters are collections of related functions, not separate processes or threads. The engine advances the state machine to a new state by automatically setting the value of the state attribute.

Each entity with state machines may have a status attribute for each state machine, in both the requested and implemented views. The status attribute may be string-valued, and provide its present status.

The SMS Monitor state machine engine may also be adapted to force inconsistent CDB data to a consistent state. The engine may treat any CDB update errors as fatal to the server. It will attempt to flag the local CDB copy as suspect, so that recovery on the backup system can proceed if possible. If all CDB copies are marked suspect, the SMS Monitor 116 may try to proceed with the most recent copy. If that attempt fails, the SMS Monitor 116 may attempt to deliver a failure notice, and cease further update attempts. In one embodiment, the system 200 may store redundant CDB information with metadata service (MDS) and bit file storage system (BSS) instances, and use this information to rebuild the CDB 114. Alternatively, the CDB 114 may be rebuilt manually.

E. Resource Management

In order to provision file systems or other computing systems, the SMS Monitor 116 determines the available resources of a given class and then makes an allocation of a given resource to a given entity or service (e.g., a file system may have MDS, BSS and gateway services or entities). For example, to provision an MDS partition for a file system being created, the SMS Monitor may use an MDS service master to find a pair of gateway/MDS-class machines which each have enough spare processing power, main memory, and disk space to accommodate the requirements of the MDS partition.

In order to handle a number of small file systems without requiring huge numbers of gateway/MDS machines, the SMS Monitor 116 may, in general, allocate less than entire machines. On the other hand, the system may have only limited knowledge about the resource requirements of certain entities, so it may use a small range of values for the resource measures.

1. Units of Allocation

The SMS Monitor 116 defines measurable units by which system performance attributes or resource values may be quantified. The types and sizes of the units may vary based on the type of system implemented and the functionality and performance attributes of that system. In the preferred embodiment, the SMS Monitor 116 defines units to measure attributes such as processing (e.g., CPU) power, memory, capacity, operations per second, response time and throughput. Several non-limiting examples of these units are listed below:

CPU unit: 0.001 of a 1 GHZ ×86-type processor (“1 MHZ”)

Memory unit: 1 MB

Disk capacity unit: 1 MB

Disk operations unit: 1 random I/O per second

Disk throughput unit: 1 MB per second

The foregoing units are arbitrary, and the assignment of values to particular system resources, such as CPUs and disk drives, may be approximate. To minimize fragmentation of resources, allocations may be rounded by an allocation utility routine to a few bits of significance.

The SMS Monitor 116 may further be adapted to measure and manage the bandwidth of the logical and physical switch ports and the gateways. In the certain embodiments, this may be a manual process, based on the known performance of the various uplinks.

2. Resource Requirements

In the preferred embodiment, various measures of service, which may be quantified or measured by the above-defined units, are included as attributes of requested view and of the implemented view. For example, file system attributes may include an average file size estimate (in bytes), a Network File System (“NFS”) operations per second estimate, a typical response time estimate (in microseconds), and a bytes per second estimate, all with defaults inheritable from the customer or the system as a whole. When the implemented view for these resources does not substantially match the requested view (e.g., when the resource requirements of the requested view are no longer being met), the SMS Monitor 116 will automatically reconfigure the system resources to match the implemented view with the requested view. Particularly, the SMS Monitor 116 will initiate the modification state machine to reconfigure the file system to ensure that the attributes of the implemented view satisfy the requirements of the requested view.

3. Modifying System Resources

The SMS Monitor 116 will automatically modify system resources to ensure that the implemented view satisfies the requirements of the requested view. The modification action or state machine may be initiated by the SMS Monitor 116 in several different circumstances. For example and without limitation, the modification state machine may be initiated when a user changes the requested view, when the state of system resources changes (e.g., when resources fail or become inoperable), when the SMS Monitor 116 detects an undesirable load imbalance on the system, and when resources are added to the system.

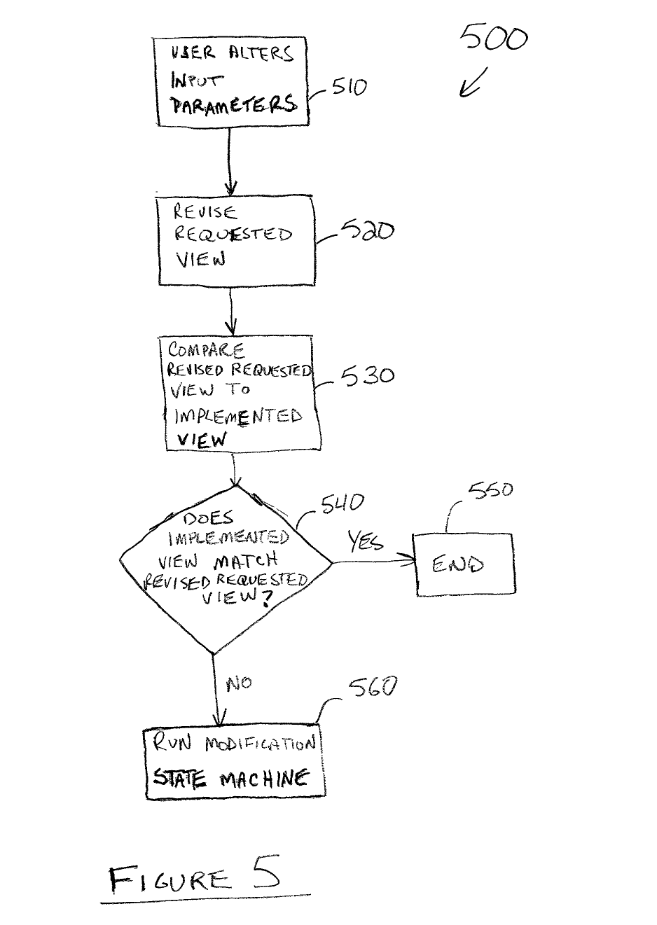

FIG. 5 illustrates an exemplary method 500 used to initiate the modification state machine when a user changes the requested view of the system, according to one embodiment of the invention. The method 500 begins when a user alters input parameters (e.g., by use of interface 204), as shown in step 510. The altered input parameters are communicated to the SMS Monitor 116, which revises the requested view to correspond to the desired changes, as shown in step 520. The SMS Monitor 116 then compares the revised requested view to the implemented view, as shown in step 530. Next, the SMS Monitor 116 determines whether the current implemented view (i.e., the current state or performance of the system) substantially matches or satisfies the requested view (i.e., the desired state or performance of the system), as shown in step 540. Because the actual configuration of the system may be designed to satisfy and fulfill increases in usage or performance standards, certain changes in the requested view might not trigger or initiate a modification in system resources. Thus, if the implemented view matches or satisfies the revised requested view, the method ends, as shown in step 550. If the implemented view does not match the revised requested view, the SMS Monitor 116 initiates the modification state machine, as shown in step 560.

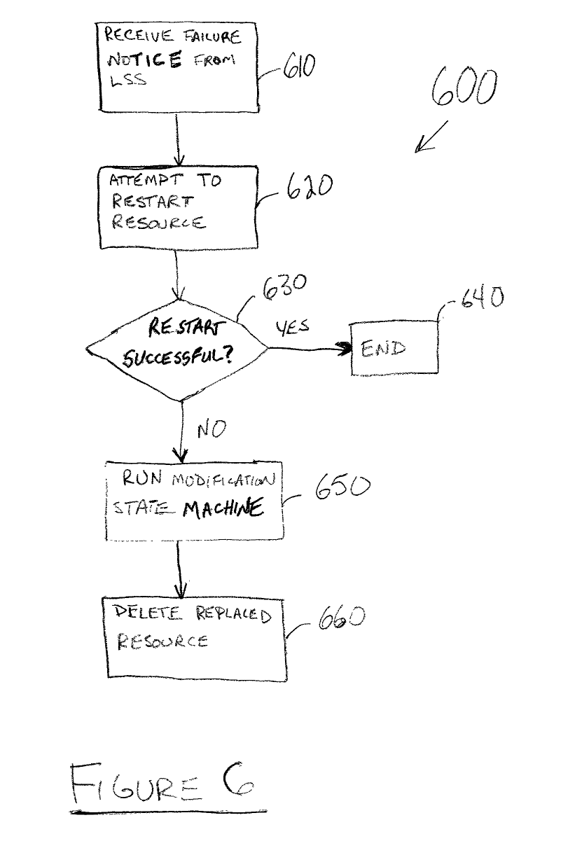

FIG. 6 illustrates an exemplary method 600 used to initiate the modification state machine when the state of system resources changes, such as when a system resource fails or becomes inoperable, according to one embodiment of the invention. The method 600 begins when the SMS Monitor 116 receives a failure notification from the LSS (e.g., a message from the LSS indicating a failure state of one or more system resources), as shown in step 610. The SMS Monitor 116 may also obtain failure notifications upon restart. Particularly, upon restart, the SMS Monitor 116 will check whether any resources it has allocated have failed or are no longer available. Upon receipt of a failure notice (or upon otherwise discovering that an allocated resource has failed), the SMS Monitor 116 attempts to restart the failed resource, as shown in step 620. For example, the SMS Monitor 116 may communicate signals to the corresponding remote power unit 115, instructing the power unit 115 to restart the affected resource. The SMS Monitor 116 then observes the operation of the resource to determine whether the restart was successful and the resource is operating properly. For example, the SMS Monitor 116 may use the LSS to determine whether the resource is operating properly. If the restart was successful, the method 600 ends, as shown in step 640. If the restart was not successful, the SMS Monitor 116 initiates the modification state machine, as shown in step 650. After the system is modified and the problematic resource is replaced, the SMS Monitor 116 deletes the replaced resource and removes it from the implemented view, as shown in step 660.

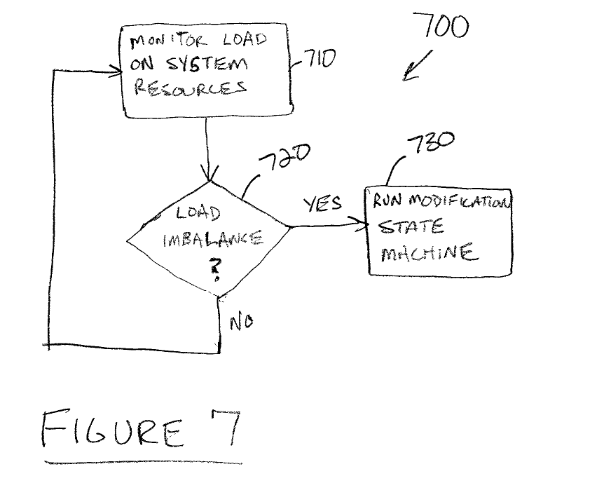

FIG. 7 illustrates an exemplary method 700 used to initiate the modification state machine when there is a load imbalance on the system, according to one embodiment of the invention. The method 700 begins in step 710, where the SMS Monitor 116 monitors the load present on the various system resources. In step 720, the SMS Monitor 116 determines whether an unacceptable load imbalance exists based upon the observed usage. Particularly, the SMS Monitor 116 may observe the usage of various system resources to determine whether the usage exceeds some predetermined acceptable level or amount (or alternatively, whether the usage falls below some predetermined level or amount). If an unacceptable load imbalance exists, the SMS Monitor 116 initiates the modification state machine, as shown in step 730.

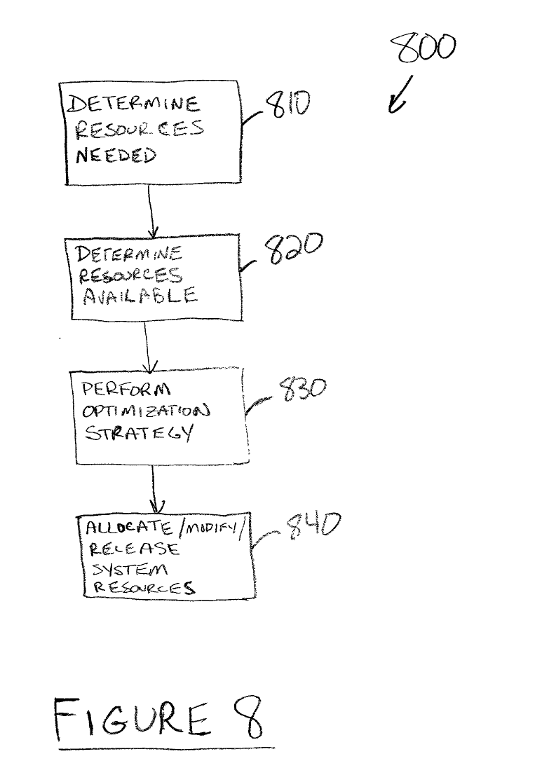

In the preferred embodiment, when the modification state machine is initiated, the SMS Monitor 116 may individually perform a modification routine for each portion or entity of the file system (e.g., the metadata service (MDS), the bit file storage service (BSS), and the gateway service (GS)). FIG. 8 illustrates an exemplary modification routine or method 800, according to one embodiment of the invention. The modification method 800 begins in step 810, where the SMS Monitor 116 determines the resources that are needed (e.g., in the prescribed units of allocation). The SMS Monitor 116 may determine the resources that are needed based on the present requested view and/or the presence and size of any load imbalances on the system. For example, the SMS Monitor 116 may review the current input parameters and actual system performance to determine the extent to which the desired capacity or performance requirements are being exceeded. The SMS Monitor 116 quantifies this observation into a measurable value using the predefined units of allocation. The SMS Monitor 116 may perform this quantification using one or more stored mapping functions. These mapping functions may be determined by prior testing and experimentation, such as by the prior measurement and analysis of the operation and performance of similar computing systems (e.g., file systems) having similar resources. By entering the performance that is required and/or the amount that the requested performance is being exceeded, the stored mapping functions may output an amount of resources that are needed in the prescribed units of allocation. For example, the function may provide a number of units needed to provide the file system service or component with the requested performance attributes.

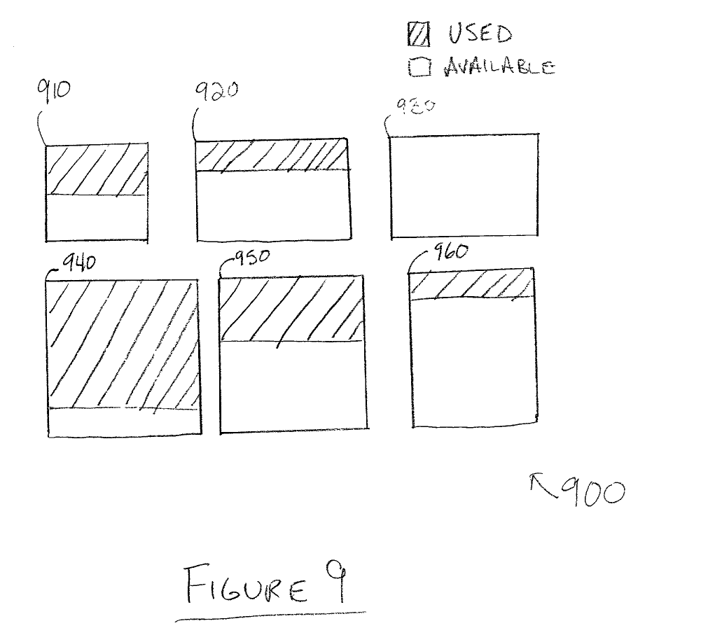

In step 820, the SMS Monitor 116 determines the resources that are presently available in the system. Particularly, the SMS Monitor 116 scans the available resources to determine the amount of units of allocation that are available and the distribution of those units. This scanning may include any new resources or host entities that may have been added to the system. In the preferred embodiment, the SMS Monitor 116 stores and updates all resource information in one or more relational tables (e.g., in the CDB 114). For example, when a machine is added to the system, the SMS Monitor 116 adds the machine to a “hosts” list and, after determining the quantity of each attribute or resource value for that machine, stores the appropriate values (in units of allocation) for the attributes in the CDB 114. As portions of the resource are allocated, the SMS Monitor 116 revises the list or table to reflect the current state of used and unused resource values or attributes for the machine. FIG. 9 illustrates one non-limiting example of a block diagram of a distributed computing system 900, having resources 910-960 of varying size and varying usage. In this example, the SMS Monitor 116 would scan resources 910-960 and determine the amount of units of allocation that are being used (shown in cross-hatching) and amount of units of allocation that are available (shown clear) for each resource. The SMS Monitor 116 may also store an “allocation-set” attribute for each host entity, where members of the set may include one or more of the service classes. For example, when making an MDS allocation, only machines labeled for use for MDS services would be considered. When a machine is added to the system, the SMS Monitor 116 may use hard-coded rules for classifying machine as to the type of service for which it may be used. In the non-limiting file system example, the SMS Monitor 116 may define the following initial classes: “SMS”, “MDS”, “GS”, and “BSS”, where “SMS” includes a boot server, logging host, LSS Monitor host, administrative Web server host and SMS Monitor host.

Referring back to FIG. 8, in step 830, the SMS Monitor 116 performs an optimization strategy to assign the resources needed to the available resources. In the preferred embodiment, the optimization strategy of the SMS Monitor 116 involves two considerations. First, the strategy attempts to minimize overhead by determining whether the resources needed can fit into a single available resource (e.g., machine). If the resources needed can fit into a single available resource, the SMS Monitor 116 may assign the resources needed to that resource. Otherwise, the SMS Monitor 116 may attempt to place the resources needed into the fewest number of available resources. For example, if the resources needed represent an MDS of 2000 units, the optimization routine would “prefer” to assign the MDS to a host having 3000 units available, rather than partitioning the MDS into two portions and assigning each portion to a separate resource having 1500 units available. By reducing the number of times the file system component is partitioned, the total overhead (or unusable space) within the system will be reduced, as will be appreciated by those skill in the art. If a new resource has been added to the system, the SMS Monitor 116 may choose to consolidate a previously partitioned file system component (i.e., a component residing in two or more resources) into the new resource in order to reduce the total overhead. Thus, it should be appreciated that the modifications performed by the SMS Monitor 116 may include the migration and/or consolidation of certain components or services to different or new resources. Second, the strategy will perform a “best fit” analysis to determine the best location(s) for the resources needed. That is, the strategy will attempt to place the resources needed into the closest matching available resource or set of resources in order to avoid creating relatively small portions of unused space that would be too small to be efficiently used for another purpose or component.

Finally, after the SMS Monitor 116 determines the optimal assignment for the needed resources, the SMS Monitor 116 allocates, modifies and/or releases the corresponding resources to match the assignment, as shown in step 840. The SMS Monitor 116 records any corresponding updates in the relational tables of the CDB 114 to reflect the current state of used and unused portions of the system resources. After a file system is modified or created, the SMS Monitor 116 will enable the system for access.

In this manner, the SMS Monitor 116 automatically modifies system resources to ensure that the implemented view consistently satisfies the requirements of the requested view.

4. Creating a File System

As previously discussed, a user may create a new file system or component using the interface 204 (e.g., by naming the file system or component and assigning the desired functions or performance attributes). The steps undertaken by the SMS Monitor 116 to create a new file system are substantially identical to the steps taken when a file system is modified. Particularly, the SMS Monitor 116 will (i) determine the resources needed for the file system using a mapping function; (ii) scan the available resources to determine the amount of units of allocation that are available and the distribution of those units; (iii) perform an optimization routine to determine the best location for the file system; (iv) allocate system resources to create the file system; and (v) enable the file system for access. In the preferred embodiment, the SMS Monitor 116 will perform this method separately for each file system component or entity (e.g., for MDS, BSS and gateway components).

5. Other File System Operations

In the preferred embodiment of the invention, in addition to the modification and creation of file systems described above in sections 3. and 4., respectively, the SMS Monitor 116 may also perform start, stop, and delete operations on file systems. The SMS Monitor 116 may run state machines to perform these operations. The file system start state machine is adapted to activate a selected file system or file system component; the file system stop state machine is adapted to deactivate a selected file system or file system component; and the file system delete state machine is adapted to delete a selected file system or file system component. The elements and function of these state machines may be substantially similar to start, stop, and delete state machines known in the art.

Of all the described state machines (e.g., create, modify, start, stop and delete), the file system stop and file system delete state machines cannot fail. If the file system create state machine fails, the SMS Monitor 116 transitions to the file system delete state machine and deletes the partially created file system. If the file system start state machine fails, the SMS Monitor 116 transitions to the file system stop state machine and halts the operation. If the file system modify state machine fails, the SMS Monitor 116 will terminate the operation such that the file system is left in a self-consistent or stable state, but not necessarily one that matches the requested view.

As described above, the state machines may be partitioned into “prepare” and “action” portions, in order to provide an opportunity for an early termination from file system operations (e.g., during the prepare portion). In this manner, the SMS Monitor saves time and resources in the event that an operation will ultimately fail. Furthermore, the state machines may also be partitioned into separate portions for each file system service entity (e.g., MDS, BSS, and GS portions).

For all of file system operations, the state changes are reflected in the “requested view” in the same transaction as updates the state in the “implemented view”. As noted above, there will be status results available in the “requested view” to clarify the cause of the state (particularly in the case of a failure). This status report may be stored in both the implemented and requested views, in the same transaction which updates the state values.

In this manner, the present invention provides a system and method for managing a distributed computing system that automatically and dynamically configures system resources to conform to and/or satisfy requested performance requirements or attributes. The system and method allow an administrator to simply input certain functionality and performance attributes to achieve a desired result, and not specifically provision system resources in order to obtain the results. The system autonomously and dynamically modifies system resources to satisfy changes made in the requested attributes, changes in the state of system resources, and load imbalances that may arise in the system. The system supports a large number of file systems, potentially a mix of large and small, with a wide range of file average file sizes, and with a wide range of throughput requirements. The system further supports provisioning in support of specified qualities of service, so that an administrator can specify policy attributes (such as throughput and response time) commonly used in service level agreements.

Although the present invention has been particularly described with reference to the preferred embodiments thereof, it should be readily apparent to those of ordinary skill in the art that changes and modifications in the form and details may be made without departing from the spirit and scope of the invention. For example, it should be understood that Applicant's invention is not limited to the exemplary methods that are illustrated in FIGS. 5, 6, 7 and 8. Additional or different steps and procedures may be included in the methods, and the steps of the methods may be performed in any suitable order. It is intended that the appended claims include such changes and modifications. It should be further apparent to those skilled in the art that the various embodiments are not necessarily exclusive, but that features of some embodiments may be combined with features of other embodiments while remaining with the spirit and scope of the invention.

What is claimed is:

1. A system for managing a distributed computing system having a plurality of resources, comprising:
at least one server which is communicatively connected to the plurality of resources and which is adapted to receive requested attributes of the distributed computing system from a user, and to automatically and dynamically configure the plurality of system resources to satisfy the requested attributes.

2. The system of claim 1 wherein the at least one server is further adapted to monitor the actual performance of the distributed computing system, to compare the actual performance of the distributed computing system to the requested attributes, and to autonomously and dynamically modify the plurality of resources to ensure that the actual performance consistently satisfies the requested performance.

3. The system of claim 1 wherein the distributed computing system comprises a file system.

4. The system of claim 3 wherein the requested attributes comprise performance attributes of the file system.

5. The system of claim 1 wherein the at least one server comprises a primary server and a backup server.

6. The system of claim 1 further comprising a plurality of agents which are respectively disposed on the plurality of resources and which are adapted to locally manage the resources under remote control of the at least one server.

7. The system of claim 1 wherein the at least one server is communicatively coupled to the plurality of resources through at least one switching fabric.

8. The system of claim 1 further comprising a plurality of remote power control units which are communicatively coupled to the at least one server and to the plurality of resources, the power control units being adapted selectively stop and reset the plurality of resources in response to control signals received from the at least one server.

9. The system of claim 1 further comprising an interface which is adapted to allow a user to enter and modify the requested attributes of the distributed computing system and to communicate the requested attributes to the at least one server.

10. The system of claim 9 wherein the interface comprises a graphical user interface.

11. A system for managing a distributed file system having a plurality of resources comprising:
an interface that is adapted to allow a user to input a requested view of the file system, representing at least one desired attribute of the file system;
a first portion that is adapted to monitor an implemented view of the file system, representing at least one actual attribute of the file system;
a second portion that is adapted to store the requested view and implemented view; and
at least one server that is communicatively coupled to the first portion, second portion and the plurality of resources, the at least one server being adapted to compare requested view to the implemented view, and to automatically and dynamically modify the plurality of resources such that the implemented view matches the requested view.

12. The system of claim 11 wherein the at least one desired attribute and the at least one actual attribute comprise performance attributes.

13. The system of claim 12 wherein the performance attributes are selected from the group consisting of: processing power, memory, capacity, operations per second, response time and throughput.

14. The system of claim 11 wherein the second portion comprises a configuration database stored within the at least one server.

15. The system of claim 11 wherein the first portion comprises a life support service.

16. The system of claim 11 further comprising a plurality of remote power control units which are communicatively coupled to the at least one server and to the plurality of resources, the power control units being adapted selectively stop and reset the plurality of resources in response to control signals received from the at least one server.

17. The system of claim 11 wherein the interface comprises a graphical user interface.

18. A method for managing a plurality of resources in a distributed computing system, comprising the steps of:
receiving a requested view of the distributed computing system, representing at least one requested attribute of the distributed computing system;
monitoring an implemented view of the distributed computing system, representing at least one actual attribute of the distributed computing system;
comparing the requested view to the implemented view; and
automatically and dynamically configuring the plurality of resources to ensure that the implemented view consistently satisfies the requested view.

19. The method of claim 18 wherein the step of automatically configuring the plurality of resources comprises the following steps:
determining resources needed for the implemented view to satisfy the requested view using a mapping function;
scanning the plurality of resources to determine the amount of resources that are available and the distribution of the available resources;
performing an optimization routine; and
configuring the plurality of system resources based upon the optimization routine.

20. The method of claim 19 wherein the optimization routine is adapted to reduce overhead.

21. The method of claim 20 wherein the optimization routine includes a best fit analysis.
